(19) United States
(12) Patent Application Publication
(10) Pub. No.: US 2020/0042915 A1
(43) Pub. Date: Feb. 6, 2020

(54) COLLABORATION SYSTEM FOR CONSTRUCTION MANAGEMENT UTILIZING SHARED COMPUTING PLATFORMS

(71) Applicant: OE CONSTRUCTION SOLUTIONS INC. (doing business as OPTIMAL EFFICIENCY), Vancouver (CA)

(72) Inventor: KARINE SAMSON, Vancouver (CA)

(21) Appl. No.: 16/469,436

(22) PCT Filed: Dec. 13, 2017
(86) PCT No.: PCT/CA2017/051511

§ 371 Date: Jun. 13, 2019

Related U.S. Application Data
(60) Provisional application No. 62/433,596, filed on Dec. 13, 2016.

(51) Int. Cl. G06Q 10/06; G06Q 10/00

(52) U.S. Cl. CPC G06Q 10/0635; G06Q 10/20

(57) ABSTRACT

A system for enabling a user to obtain extensive relevant data on a single project, the system comprising at least two of: a nexus module; a logistics module; a health and safety module; an artificial intelligence module; a field management module; a software integration module; a cost control module; a contract administration module; a augmented reality module; and a block chain module.

### CROSS REFERENCE TO RELATED APPLICATIONS

The present application claims priority to U.S. provisional patent application No. 62/433,596 filed Dec. 13, 2016.

### FIELD OF THE INVENTION

This present invention relates to a comprehensive project design, operation, maintenance administration project management system and method.

### BACKGROUND OF THE INVENTION

Construction, process improvement and maintenance projects are typically known for their inability to meet cost and time allocations, which combined with material and administrative inefficiencies, may result in errors, omissions and losses. Examples that may cause project overrun include: delays in decision making, document processing time, conflicts between materials and trades due to poor coordination, planning and design, lost or damaged assets due to poor tracking and warehouse or stockyard management, mistakes in design documents, absence of real-time collaboration and coordination, inability to foreshadow potential problems, and or poor record keeping and document handling.

It is widely known that construction is an industry where 35% of the costs may be accounted for by material waste and remedial work. It is therefore desirable that tools and systems become available to the industry that can help reduce delays, costs and process inefficiencies.

### SUMMARY OF THE INVENTION

It is to be understood that other aspects of the present invention will become readily apparent to those skilled in the art from the following detailed description, wherein various embodiments of the invention are shown and described by way of illustration. As will be realized, the invention is capable of other and different embodiments and its several details are capable of modification in various other respects, all without departing from the spirit and scope of the present invention. Accordingly, the drawings and detailed description are to be regarded as illustrative in nature and not as restrictive.

In one embodiment the invention provides a system for enabling a user to obtain relevant data relevant to a single project, the system comprising at least two of: a nexus module; a logistics module; a health and safety module; an artificial intelligence module; a field management module; a software integration module; a cost control module; a contract administration module; an augmented reality module; and a block chain module.

In another embodiment the invention provides a method for enabling a user to obtain relevant data about a single project using conventional artificial intelligence techniques such as set theory, sorting algorithms and natural language processing, the method further comprising: processing and sourcing user access requests; acquiring and interpreting data; determining the relevance of interpreted data and assigning a representative value to the interpreted data; transferring interpreted data to the assigned module; predicting risks by comparing the interpreted data to predetermined targets; and generating a report and or a notification alert. These may be adaptive or learning systems.

### DESCRIPTION OF THE DRAWINGS

Referring to the drawings, several aspects of the present invention are illustrated by way of example, and not by way of limitation, in detail in the figures, wherein:

FIG. 1 is a flow chart illustrating data acquisition, transfer, interpretation and characterization into the system.

FIG. 2 is a flow chart illustrating a scenario where the data presents deviations or risks.

FIG. 3 is a flow chart illustrating data acquisition using sensor nodes.

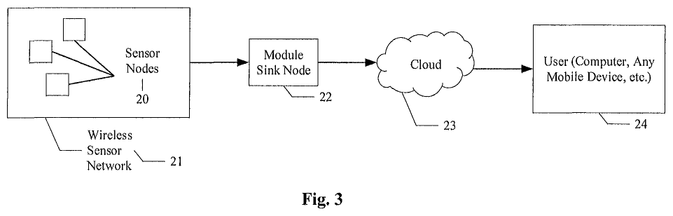

FIG. 4 is a flow chart illustrating parameters that may be set by default or predetermined.

FIG. 5 is a flow chart illustrating data acquisition using sensor.

### DETAILED DESCRIPTION

The detailed description set forth below in connection with the appended drawings is intended as a description of various embodiments of the present invention and is not intended to represent the only embodiments contemplated by the inventor. The detailed description includes specific details for the purpose of providing a comprehensive understanding of the present invention. However, it will be apparent to those skilled in the art that the present invention may be practiced without these specific details, and is limited only by the claims.

The collaboration system of the present invention may provide effectively any and all relevant information about a project in a single location or interface that may be accessible to a user in real-time. The present invention may provide a tool that connects substantially any and all components of a construction or operational project from the bidding stage, the commissioning stage and the client hand over stage. It can enable real-time communication between substantially any and all parties engaged in a project, including engineers, architects, general contractors, subcontractors, owners (for example real estate developers, mining companies, oil and gas companies, governmental organizations, etc.), vendors, suppliers etc. from any location using a wireless network with GPS or any other digital and or electronic system with location functions. Moreover, the system may be customized to a user's specific needs or the needs of a project, customers or service providers, etc. The system also provides predictive analysis capabilities providing an understanding of risk areas, calculate costs, schedule changes, errors, slippage, etc. and may be an adaptive or learning system.

Some potential benefits of the technology over current available technology may include: savings on total project costs (amount of savings depending on the nature and scale of the project); reduction of schedule and safety risks due to the integration of operational and business intelligence functions; quicker, more informed decision-making as appropriate action may be taken proactively instead of reactively; access to relevant data in real time through all levels of management; integration of technology into existing management systems or software delivering functions that may not be offered by current technology; and project execution with tighter process controls.

The system may comprise a Nexus module, a logistics module, a health and safety module, an artificial intelligence module, a field management module, a software integration module, a cost control module, a contract administration module, an augmented reality module and a block chain module. One skilled in the art would appreciate that some of these various modules maybe omitted, or rearranged or adapted in various ways. In general, the system provides one single or unified tool or interface for a user to access essentially any relevant data on a project, thereby facilitating better understanding of the project, enabling predictive analysis and minimizing losses of time, resources and money.

The Nexus module may comprise a structured or unstructured database with all documentation pertaining to a project. Each piece of information or data may have metadata assigned to it that may provide the associated document with a unique identification and classification. The metadata may be assigned to a document depending on the substantive content of a document, its origin, the author, links to other documents or data, etc. When a user has signed onto the system, the document may upload into the database automatically from their device or by manual input with metadata being automatically assigned to the document. Once the data has been uploaded, the metadata assigned to the document can prescribe the type of user or authentication profile that may access the document. Relevant or non-relevant data may be saved to the module. The Nexus module provides raw and interpreted data. The Nexus module may provide real time collaboration between different users to review, analyze and work with the data. The system may contain all documents of a project including highly confidential documents. Documents may be further tagged with the user access rights. A tag pairing functionality within the module may provide certain highly confidential documents to a restricted group of users. The Nexus module may access a list of users and their access rights to documents within the database.

The Nexus module may provide correlations between interpreted data and pre-determined default data within the Nexus module database using a variety of functions. The module provides the option to import or export data internally within the system and externally outside the system. The module also provides the option of combining imported data with data from the database of precedent or default parameters to perform predictive analysis. Substantially all user-facing inputs may be customized for example via a dashboard interface i.e. assembling, organizing and visualizing of the data.

The field management module may include for example the following functionalities: time keeping, task assignment, asset management, inspection reports, toolbox meeting reports, financial and progress field reports, document sharing, mark up and punch list functionalities. In current industry practice, this information may be in hard paper copy and filed away without ease of access. However, in the present invention this information may be electronically available and allows the artificial intelligence module to access the data together with all other documentation in the Nexus module providing relevant interpreted data that may be further processed, analyzed, characterized, etc. by importance, relevance, time sensitivity, etc. After the data has been processed, trends, risks and deviations may be extrapolated and predictions or notifications can be reported. The raw data from the Nexus module may be accessed by or provided to the field management module, where it may be stored and accessible by other modules of the present invention.

The health and safety module (“HSE”) may include a reporting system with geotagging of reported items, such as job safety analyses, the daily site inspection report, accident and incident reports, etc. The reporting items may be based on daily worksite safety assessments. Reporting can be linked by geotags to a real-time site plan. The observations concerning a reporting item can be categorized into different groups, such as housekeeping, dangerous work practice, dangerous equipment, best practice or non-compliant procedures etc., which provide a holistic understanding of the project with respect to HSE in its entirety. The data received through a reporting item along with reported accident and incident data may be used to create a matrix based risk evaluation with location specifics. The inputted data can also be manipulated by the system to predict the probability of accidents and incidents that may occur and allow a user to understand the root cause or likely location of the risk and take proactive corrective measures to avoid the risk. In a first step, accident and incident reporting may be performed so that a CSV file can be produced by the system, which may further provide for example an official report to the local authorities. In a second step, the official report may be integrated into the HSE module. Once a report is completed, a user with the appropriate user profile may make the report available from the reporting module to the appropriate regulatory bodies. The HSE module may also contribute to the notification and alert module and uses predictive analysis functionalities, further described below, that may update users on safety related news and or reporting and alert the user to any risks.

The logistics module may include an online shipping and ordering protocol that is updated and automatically populated in real time. Shipments may be tracked for example by using GPS tags or smart container technology. Shipping documents as well as documentation pertaining the cargo of the shipment (MSDS, transportation and storage information, shipping manifest, customs and other government forms) may also be available in the module. In addition, the module may provide a link between logistics and warehousing assuring adequate storage and planning of resources for example planning ideal storage condition or time of delivery from the storage facility, staging and intermediate assembly and subassembly fit and test activities.

The contract administration module may include substantially all agreements, binding or non-binding contractual relationships as well as activities and documentation relevant to bidding, such as: approved suppliers and contractor lists, requests for bids, requests for quotes, bid evaluation forms, creation and execution of contracts and purchase orders. This module may include tools and functionalities to expedite activities related to contract administration for example such as automatic form filling, standard form templates for specific contractual relationships, etc.

A cost control module may include a data collection and processing functionality that receives input of expenses and cost data from other modules. The module may also include a database of cost and estimates data from substantially any previous project precedent or default parameters. The cost control module may integrate with and/or incorporate an accounting software. Features of the module also include data mining and predictive analysis, which may provide trend analysis, estimation of budget targets and milestones or by providing scheduling data. The cost control module provides a user with ready access to high quality, real-time knowledge about the project, empowering the user with the opportunity to make informed decisions.

The software integration module may include supplying nodes, links and networks to logically or physically connect to other relevant software and data used by the user. For example, users may run a third party software for scheduling or bookkeeping. This module allows for the communication between the third party software and the system, wherein the data from the software may be transferred to the system and vice-versa.

The artificial intelligence module may include data mining, machine learning, predictive analysis and problem solving. This module collects data from the other modules and may feed data back to the systems that was mined, analyzed, categorized, etc. to cause reporting or notifications and alerts. If potentially harmful trends are detected by the module, a notification to users may be triggered. The notifications may escalate to different users or higher levels of management ensuring the risk is mitigated. The module may also propose solutions based upon trained learning from precedent projects within the Nexus database.

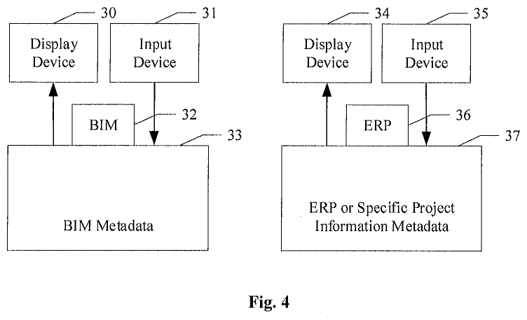

Predictive analysis uses techniques such as data mining, statistical algorithms and modeling to process and analyze data. It may provide analysis of a parameter in relative comparison with an expected target. The system may display the variation between current data and expected parameter targets. Identification of potential abnormalities may be based on parameters set by default for example parameters set by default using BIM, ERP or customized project targets. Referring to FIG. 4. predictive analysis may receive input data from a user 31 or 35, using BIM 32 or ERP 36 data as a precedent or default, the system formulates targeted parameters from BIM metadata 33 or ERP metadata or customized project specific targets 37 and displays this to the user 30 or 34. Predictive analysis may provide projections, forecasts, pattern recognition trends based on linear or non-linear data. In addition, predictive analysis may assess the likelihood of an event, for example by providing a score number generated by the artificial intelligence module that incorporates substantially all interpreted relevant data. The module may also identify factors that may lead to an abnormality, deviation or undesired event perhaps together with probability of occurrence. If the module recognizes a negative pattern, a report or alert may be generated providing suggested actions to remediate or mitigate the negative pattern.

The augmented reality module may include visualization knowledge and computational analysis data and output of the other modules. Augmented reality may be a live direct or indirect view of a physical, real-world environment whose elements are “augmented” by computer-generated or extracted real-world sensory input. Augmented reality can enhance a user's current perception of reality. The module may provide an overlay of data gathered from various other modules, or from a device such as special glasses, a mobile device, a hardhat, etc. In another example a user could overlay a document and drawing with a Building Information Model (BIM) model for a construction project. The module may also be used to actively communicate or display content outside of the system for example in BIM database or a smart phone, smart device, mobile device etc.

The block chain module may include a mechanism to efficiently verify fund and document transfer between stakeholders, logistics, transactions identity management, security and trust authentication and similar information, avoiding or reducing requirements for third party due diligence or security assurances. The block chain module may create a non-corruptible record for assigned and interpreted data (for example a drawing or a document) and may eliminate third party verification of a transaction. Using the block chain module a user may send electronic documents externally in real time substantially avoiding any third party verification.

Substantially all raw, assigned and interpreted data and information may be accessed through the Nexus module. All other modules are connected to the Nexus module. The Nexus module provides access to substantially all of the information and data on the system to substantially all of the modules. The Nexus module also provides communication between modules.

The system may require a user to login to identify the user and authenticate the user credentials allowing the system to identify the level of access afforded a user. The user may then access different modules, alerts, reports and data on the system.

The present invention may optionally include management level strategy by integrating an alarm notification system. Different levels of access may be set up for each category of users. There may be default settings attributed to each kind of user but such settings may be changed and customized. The software may also include and integrate BIM technology and may be interoperable with any existing planning, logistics, location-based, accounting, block chain or other software (Primavera P6, MS Project, etc.).

The system may deliver a business intelligence function by providing predictive analysis and a visualization tool (augmented reality module) from any device for example from glasses or hardhats.

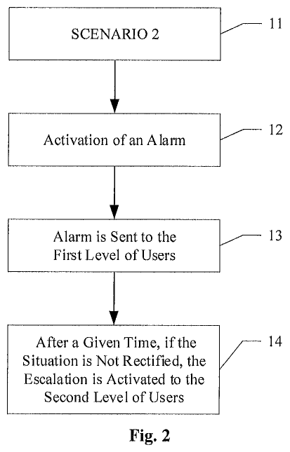

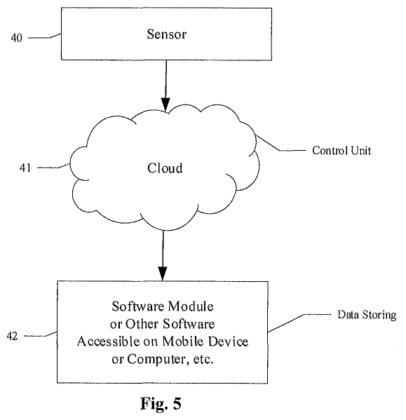

Referring to FIGS. 2 and 5 the first step of the data acquisition may be based on the internet of things, intelligent electronic labels, scanning technology or by other means that enable data collection in real-time from any data source such as a sensor 40 or a sensor node 20 from any location including construction, operational and administrative sites provided that there exists a network 21 connection, The information can be provided to an end-point module or node 22 such as any mobile device, IOS, Android, wearable device, or any other smart platform. The data may be transferred to a server or a cloud server 23 or 41. Based on algorithms, the relevant data may be processed and transferred to the assigned modules 42 of the system. The data may be accessed by a user using a preconfigured user interface 24 such as a computer, mobile device, smart device, augmented reality device, etc.

Through the internet of things, sensor data from equipment, machinery, workers as well as data from the field reports may be collected and stored in the Nexus module. Artificial intelligence and search algorithms may process and analyze the data. While all interpreted data may be stored in the Nexus module, the relevant data may be subject to predictive analysis and may be transferred to or shared with other modules. Produced trends from predictive analysis may trigger notifications or alerts to specific users, groups of users or levels of management prompting them to take corrective action (if they deem it necessary before the problem manifests itself in a major risk). The data collection and alerting may occur within different modules or within the Nexus,

Business intelligence may be integrated into the totality of the system ensuring that any deviations from pre-determined parameters such as the default or database precedents (e.g. the temperature of a building, the oil level of an engine, a projected schedule delay, a projected budget cost exceeding for a specific activity, an abnormal number of hours used by an equipment, etc.) may be communicated to an appropriate user and the data may be appropriately analyzed within different modules. A report may be generated and issued to the appropriate module and or user.

The notification system may be customized. For example, the first level of notification may be to a superintendent. After a given time, if the situation is not rectified, the notification may be sent to a subsequent level of management for example to a project coordinator and so on.

The system further comprises of a control and monitoring system for any kind of field data including labor hours, equipment hours and conditions, working environment conditions, building information, etc. Any one of the parameters may be customized.

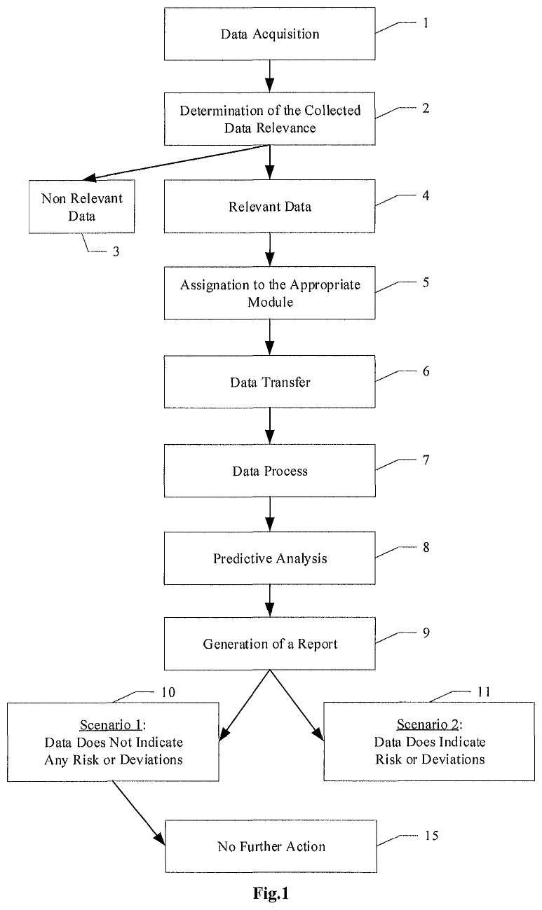

Another aspect of the invention provides a method for enabling a user to obtain relevant data on a single project using conventional artificial intelligence techniques such as set theory, sorting algorithms, natural language processing, picture processing, neural networks or deep learning algorithms. Referring to FIG. 1 the method may comprise of processing a user into the system; acquiring 1 and interpreting data; determining 2 the relevance 4 or non-relevance 3 of the interpreted data and assigning a representative to the interpreted data 5; transferring 6 interpreted data to the assigned module; characterizing, further processing 7 and analyzing the interpreted data; analyzing and predicting 8 risks in the project by reference to interpreted data element; generating a report 9; and generating a notification alert or taking no further action 15.

The method may include enrolling of a user into the system. This may be achieved for example by importing users from a previous project, importing a list of users from an external CSV file or manual entry. When the user information is processed in to the system, the user is assigned access rights; these rights may be customized or varied. The user may also be assigned tags, which also help identify the user and the user's access rights such as trade, competencies, authentication profile, areas of practice, etc.

The method may also include processing and uploading of document to the Nexus module, This information may be received for example from a hard drive or from a computer. Uploading may take place using a drag and drop function or by marking documents for transfer into the system after activation of the upload document function. Documents uploaded to the Nexus module may be in a true PDF format.

Once data is uploaded, the method may further include an assignment of a representative for example metadata or tags providing characterisation of the data. The Nexus module possess a function capable of reading a true PDF and may identify the document title, number, revision etc. and auto-assign metadata to the document. Additional metadata may be custom assigned for a document or group of documents. Substantially all or any documents in the system contain metadata. Documents may also be assigned tags, these tags may correspond to user access tags thereby permitting a user access to the document or they may not correspond to a user access tag thereby prohibiting a user access to the document. Document tags may be customizable or default pre-programmed tags based on default or a database of precedent projects. Notifications may be sent for example by direct messages to the user when the user obtains access to documents. Notifications can also be accessed from substantially any device used by the user for example a laptop, desktop, a mobile device, tablet, an augmented reality device, etc.

Once interpreted data is assigned a representation it may be assigned to the module for further analysis, processing and or characterisation.

The data may be further analyzed and the methodology described above for predicting risks may be performed. Referring to FIG. 2 if the data deviates or the predictive analysis demonstrates a projected deviation from the standard default parameters or pre-determined parameters based on precedents or by customized (adaptive) parameters 11, then an alarm is activated 12 in the system and may be sent for example to a first level of users 13. After a given amount of time, if the situation is not rectified, the notification may be escalated to a second level of management 14 and so on. A report and or a notification alert may be generated based on the predictive analysis. If a report or notification is created, then this data may possess metadata and tags that correspond to the originating data or it may possess new metadata and tags depending on the sensitivity, confidentiality and relevance of the interpreted data. The metadata and tags may determine the user profile that can access the notification or report.

Information (e.g. drawings, plans, specifications, safety procedures, mechanical inspections, schedule, etc.) can be remotely uploaded, accessed and updated in real-time. The information may be processed and analyzed and a predictive analysis report may be generated. The actual and or projected deviations from the default or pre-determined parameters may be analyzed along with any type of relevant impact (e.g. on the schedule, cost, safety, environmental, etc.). Analytics and statistics reports may be generated.

The features of the complete system may include:
Instant takeoff counts from PDF files by character recognition. The system may retrieve data such as the document number, title and specific keywords from a true PDF document and autofill the metadata for the document within the Nexus module and set some of the keywords as tags for the document.
Identification of changes between two versions of a document by a superposing method, or any suitable document management sub-system
Determination of volumes, surface areas and linear measurements from a visualization document by pointing and clicking (on PDF documents).
Generation of a material lists based on precedent projects (in the database of the system) that may be similar or example similar projects in the database.
Calculation of materials, labor, equipment and waste based on typical project teams or crews that may be required to perform a specific scope of work,
Determination of the production rate factor (in reference to precedents—similar past projects).
Determination of costs, expenses, margins, etc.
History of previous project materials and equipment purchases and rentals for example the suppliers, main contacts information, price previously paid, etc.
Pricing templates—using the precedents that may be been provided to a supplier.
Automatic purchase order issuance thereby allowing the user to merely enter the supplier name and the related information may be automatically populated into the project file, sent for purchase and linked to an accounting department and jobsite data.
Logistic module enabling efficient ordering of materials for timely shipping by boat, barge, train, road or plane, and calculating the expenses automatically to provide a user with a cost effective option. In addition, facilitating the coordination of the flights and accommodation for staff. Through GPS, digital or electronic system with positioning function, the system may provide the location of equipment and materials (and personnel) to any device.
Location tracking of workers,
Daily reports logging any observations (for example by voice dictation) and photos from a mobile device. Through the system, a user may send final reports to specified users.
Progress pictures may be included, with description (by voice dictation for instance) and videos with description can be taken through walking on the jobsite.
Timesheets may be automatically generated by an appropriate user profile from any device.
Equipment maintenance alarm notifications may be generated. For example, customizable parameters include temperature, pressure, levels, etc. that may monitored and any deviations may be communicated to the designated users.
Equipment hours tracking may provide useful information with respect to allocation of hours of specific activities, or maintenance cycles.
Alarm notification may be generated for abnormal equipment's operation hours (e.g. unused equipment, operation out of regular work hours, overtime, etc.).
The system may track the production rates and projected schedule as well as provide cost impacts.
Automatic schedule updates may be provided to any user.
Automatic progress billing may be generated.
Alarm notification may be generated for forecasted costs exceeding the budget, with impact on schedule and cost project. A graph showing the projection of costs over time may be generated.
The drawings and specifications feature may ensure that the latest versions of drawings and specifications are used and facilitates the sharing of documents from any device.
Drawings may be modified on a PDF or other file from any device including for example redlines, markups, notes, screen shot of a specific portion, etc. to facilitate communication of proposed changes.
A document control system feature tracks the changes and the user who made them, along with the date. Furthermore, it may track and authenticate (blockchain verify) the status of the various documents such as RFIs, submittals, transmittals, email tracking, project correspondences, meeting minutes, contacts directory, inspections, observations, punch list, scheduling, bidding, budget and forecast, change orders, contract management, timesheets, daily reports, safety inspections, incident reporting, QA/QC inspections, billing and invoicing, permit management, subcontractor management, supplier management, task management, etc. Notification reminders and updates may be sent to the user responsible and or assigned for a specific task or action.
The system also provides measurements on any drawing uploaded to the nexus from any device.
Predetermined default or customized key performance indicators may be used to enhance reporting and track progress.
Alarm notification may be sent to the appropriate user for any Material Safety Data Sheet (MSDS) and or permit expirations.
The job safety and or hazard analysis may be shared with all users.
The database may provide the users with sustainable construction and design methodologies such as LEED construction, which may involve incorporating adaptations for energy efficient buildings and utilities construction, use of energy efficient machinery, adding energy efficient production processes to areas such as automation, control technology, efficient engines, and heat recovery.
The system also provides automatic creation of temporary signalization plans for a construction phase.
The system may also provide a visual tool showing the actual and projected interdependencies between different trades, conflicting materials between different systems and any discrepancies.
A visualization tool may show the progress of the construction in 3-D and provides a user with the option to visualize the impact of any kind of change for example the materials, size of material, changes in the construction phases, etc.
A simulation program may be available to the user to show any deviations from the original design.
Automatic creation of contracts and reminders for contract renewal may also be available to the user.
The user may access automation of processes for example design, bidding, shop fabricating, etc.
GPS or any digital and/or electronic system with positioning function may track substantially any and all desired assets and personnel.
Integration of augmented reality devices may enable customized training programs for users.
Alarm notification system may be connected to sensors monitoring a user's health and safety conditions including local air temperature, body temperature, measurements of fatigue, pressure, heart rate, oxygen saturation level, inhalation, expiration activity, motion of moving, ambient relative humidity and expiration humidity. The alarm notification may include all types of alarms such as visual, audio, SMS, email, etc.

TABLE 1
Shows an example list of folders in a hierarchical
directory that may be used in a project.

| | |
|---|---|
| 1.0 | General: |
| 1.1 | Contacts directory |
| 1.2 | Human Resources |
| 1.3 | Contracts |
| 1.4 | Past projects archive |
| 2.0 | Bidding: |
| 2.1 | Production rates on previous projects to be used in the estimates |
| 2.2 | Suppliers lists |
| 2.3 | Quotations from suppliers and subcontractors |
| 2.4 | Estimate spreadsheets |
| 3.0 | Office documentation: |
| 3.1 | Drawings |
| 3.2 | Specifications |
| 3.3 | Request for information (RFIs) |
| 3.4 | Project correspondences (email tracking) |
| 3.5 | Submittals |
| 3.6 | Transmittals |
| 4.0 | Field documentation: |
| 4.1 | Daily reports |
| 4.2 | Weekly reports |
| 4.3 | Equipment hours of operation |
| 4.4 | Equipment transfer |
| 4.5 | Asset management |
| 4.6 | Progress pictures and videos |
| 4.7 | Permits |
| 4.8 | Subcontractors management |
| 4.9 | Suppliers management |
| 4.10 | Tasks management |
| 4.11 | Shipping logs |
| 4.12 | Automatic schedule update |
| 4.13 | Automatic progress meeting minutes |
| 5.0 | Safety: |
| 5.1 | Incident reporting |
| 5.2 | Work permit |
| 5.3 | MSDS (Material safety data sheet) |
| 5.4 | Procedures |
| 5.5 | Execution plan |
| 5.6 | Job safety analysis |
| 5.7 | Health & safety site inspection |
| 5.8 | Observations |
| 5.9 | Near misses |
| 6.0 | QA/QC: |
| 6.1 | Material site receiving |
| 6.2 | QA/QC inspections |
| 6.3 | QA/QC reports |
| 6.4 | Punch lists |
| 7.0 | Financial: |
| 7.1 | Change orders |
| 7.2 | Budget and forecast |
| 7.3 | Cost control |
| 7.4 | Progress billing |
| 7.5 | Invoicing |
| 7.6 | Account receivable |
| 7.7 | Account payable |
| 7.8 | Payroll |

Table 1 is merely an example and those skilled in the art would appreciate that some folders may be omitted, rearranged or new folders may be added.

1. A system for enabling a user to obtain data relevant to a single project, the system comprising at least two of:
a nexus module;
a logistics module;
a health and safety module;
an artificial intelligence module;
a field management module;
a software integration module;
a cost control module;
a contract administration module;
a augmented reality module;
a block chain module;
a notification module.

2. A method for enabling a user to obtain relevant data on a single project, the method comprising:
processing user access;
acquiring and interpreting data;
determining the relevance of interpreted data and assigning a representative to the interpreted data;
transferring interpreted data to the assigned module;
predicting risks by comparing the interpreted data to predetermined targets; and
generating a report and/or generating a notification alert.

3. The system of claim 1, wherein the system is preconfigured to provide a user interface on a computer graphical display.

4. The system in claim 3, where the user interface is provided via a conventional personal computer, mobile device, smart device, tablet or augmented reality device.
